(19) United States
(12) Patent Application Publication
(10) Pub. No.: US 2025/0167260 A1
(43) Pub. Date: May 22, 2025

(54) SEALING ARRANGEMENT, BIPOLAR PLATE AND ARRANGEMENT FOR AN ELECTROCHEMICAL SYSTEM AND ELECTROCHEMICAL SYSTEM

(71) Applicant: Reinz-Dichtungs-GmbH, Neu-Ulm (DE)

(72) Inventors: Jonas LEISCHER, Neu-Ulm (DE); Franz SCHWEIGGART, Pfaffenhofen (DE); Hans WALDVOGEL, Krumbach (DE); Steffen ERTHLE, Dornstadt (DE); Andreas MICHALKE, Ulm (DE)

(21) Appl. No.: 18/949,491

(22) Filed: Nov. 15, 2024

(30) Foreign Application Priority Data
Nov. 16, 2023 (DE) 20 2023 106 769.7

(51) Int. Cl. H01M 8/0273; C25B 9/75; C25B 9/77; C25B 11/036; C25B 13/02; C25B 13/08; H01M 8/0258; H01M 8/0284; H01M 8/242

(52) U.S. Cl. CPC H01M 8/0273; C25B 9/75; C25B 9/77; C25B 11/036; C25B 13/02; C25B 13/08; H01M 8/0258; H01M 8/0284; H01M 8/242

(57) ABSTRACT

The present disclosure relates to a sealing arrangement, a bipolar plate, an arrangement for an electrochemical system, and an electrochemical system. The sealing arrangement comprises a frame-shaped layer, a first elastomeric sealing element and/or a second elastomeric sealing element, and an elastomeric fluid guide structure. The frame-shaped layer has a cut-out extending over an electrochemically active region, and a through-opening for passing a fluid. The first sealing element lies against an inner edge of the through-opening and projects laterally into the through-opening in order to seal the through-opening. The second elastomeric sealing element lies against an inner edge of the cut-out and projects laterally into the cut-out in order to seal the cut-out. The elastomeric fluid guide structure has a plurality of fluid passages for passing fluid from the through opening to the cut-out or vice versa.

### CROSS REFERENCE TO RELATED APPLICATION

This application claims priority to German Utility Model Application No. 20 2023 106 769.7, entitled “SEALING ARRANGEMENT, BIPOLAR PLATE AND ARRANGEMENT FOR AN ELECTROCHEMICAL SYSTEM AND ELECTROCHEMICAL SYSTEM”, filed Nov. 16, 2023. The entire contents of the above-identified application is hereby incorporated by reference for all purposes.

### TECHNICAL FIELD

The present disclosure relates to a sealing arrangement, a bipolar plate and an arrangement for an electrochemical system and an electrochemical system. The electrochemical system can be a fuel cell stack, an electrolyser or a redox flow battery, for example.

### BACKGROUND AND SUMMARY

In general, electrochemical systems such as electrolysers or fuel cell stacks typically comprise a stack of individual electrochemical cells, each having a plurality of layers including at least one separator plate and a membrane electrode assembly (MEA), each individual cell being bounded by two adjacent separator plates. The stack of individual electrochemical cells can have two end plates that press the individual electrochemical cells together and give the stack stability. Furthermore, the individual electrochemical cells can comprise gas diffusion layers (GDL) or porous transport layers (PTL), which are arranged between the separator plate and the membrane electrode assembly. The separator plate can fulfil several functions: indirect electrical contacting of electrodes of the membrane electrode assembly (MEA), separation of media such as water, oxygen or hydrogen and electrical connection of the neighboring individual electrochemical cells. The separator plate is often also referred to as a bipolar plate.

The separator plate comprises at least one through-opening, sometimes also called a port, as an inlet or outlet for passing a fluid through the separator plate, a flow field with an electrochemically active region, and a fluid guide structure located therebetween for guiding the fluid between the through-opening and the flow field.

The separator plate can be single or multi-layered, for example. While separator plates in fuel cells are often double-layered so that cooling fluid can flow between the two individual layers, separator plates in electrolysers are usually single-layered as additional cooling is not necessary. Double-layer separator plates are sometimes also used in electrolyser applications. In this case, for example, the flow field can be designed as an additional metallic layer, which is mounted on a metallic base plate to form the bipolar plate.

In addition to the aforementioned separator plates, MEA, GDL or PTL, other layers can also be provided. Cell frames and/or cell seals can be arranged between adjacent separator plates to seal the cells. The stack of individual electrochemical cells must be sealed off from an external space, as a fluid or medium inside the individual electrochemical cells is often under excess pressure compared to the external environment. The fluid may, for example, comprise hydrogen, air or oxygen, water and/or mixture(s) thereof. In an electrolyser, the pressure difference between the environment and the inside of an electrochemical cell can often be more than 20 bar. For example, the pressure on the product side, for example the H₂ side, may be up to 40 bar, while the pressure on the reactant side, for example the H₂O side, is only up to 2 bar. It is therefore important to seal off the flow field of the fluid from the external environment and also within the electrochemical system. For this purpose, the electrochemical system can have at least one cell frame running around the outer edge of the individual electrochemical cell for each of the individual electrochemical cells in order to achieve a sealing effect. In addition, the electrolyser can comprise one or more sealing layers or cell seals for each of the individual electrochemical cells in order to reinforce the sealing effect.

Sealing beads formed in the separator plates, elastomer seals molded onto a metallic layer of the separator plate or combinations thereof are often used to seal the flow field and/or the through-openings. To avoid leaks, it is important that the elastomer seal is bonded as firmly as possible to the metal layer. If the elastomer seal no longer seals well, the separator plate including elastomer seal and metal layer must be replaced in the event of repair or maintenance. If the separator plate is to be reused, the elastomer seal must be removed at great expense and a new elastomer seal must be applied.

The aforementioned elastomer seals or sealing beads are located in the main force connection, i.e. along the direction of the compression force used to press the stack of separator plates together. Reliable pressing of the seals over the entire stack is therefore usually heavily dependent on manufacturing tolerances and operating situations. The operating pressures of modern electrolysers, of up to 40 bar or even more, can therefore quickly become a problem with the seals currently used.

In conventional sealing concepts, a groove formed in the metallic layer is often provided to accommodate an elastomer seal, whereby the elastomer seal is usually injection-molded into the groove. Due to the groove and the injection-molded elastomer seal, the space required in the pressing direction is relatively large. In addition, the metallic layer in such sealing concepts is in contact with the fluid, which has an influence on the choice of material for the metallic layer.

There is therefore a continuous need to further increase the tightness of the system, to prevent or at least reduce pressure loss or fluid loss and/or to increase the safety of the system. The present disclosure was conceived to meet this need and/or to at least partially solve the aforementioned problems.

According to a first aspect, a sealing arrangement for an electrochemical system is proposed. The sealing arrangement comprises:
a frame-shaped layer with a cut-out, wherein the layer surrounds, in the form of a frame, an electrochemically active region, wherein the cut-out extends over this region and has an inner edge, wherein the layer additionally has at least one through-opening with an inner edge for passing a fluid, and
a first elastomeric sealing element that rests against the inner edge of the through-opening and projects laterally into the passage opening in order to seal the passage opening and/or
a second elastomeric sealing element that lies against the inner edge of the cut-out and projects laterally into the cut-out in order to seal the cut-out.

This means that only the first sealing element, or only the second sealing element, or a combination of both sealing elements can be provided. Such a sealing arrangement is sometimes also known as a cell frame, as the sealing arrangement extends in the shape of a frame and is suitable for use in an electrochemical cell, in particular for sealing the electrochemical cell. The sealing arrangement can, for example, be provided on the cathode side and/or on the anode side in an electrochemical cell.

When used as intended, the sealing arrangement is pressed together with other elements or layers. When the sealing arrangement is pressed, the first sealing element and/or the second sealing element are typically in the force shunt and are pressed laterally or radially in the direction of the regions to be sealed, i.e. the through-opening or cut-out. This has the advantage that manufacturing tolerances and operating parameters play a lesser role with regard to the sealing potential.

It may be provided that the first sealing element is in circumferential contact with the inner edge of the through-opening and/or that the second sealing element is in circumferential contact with the inner edge of the cut-out. When the sealing arrangement is used as intended, the first sealing element and/or the second sealing element are usually in contact with the fluid. The sealing arrangement is usually designed so that the layer does not come in contact with the fluid, see description below. This means that materials can be used for the layer which are not normally suitable for use in the electrochemical system due to their contact with the fluid. For example, plastics, metals or combinations thereof can be used for the layer, which are cheaper and/or easier to process than materials conventionally used for the cell frame, such as stainless steel or titanium.

The layer often has a first side (first flat side) and a second side (second flat side), which are arranged opposite each other and generally extend over a large area. It may be provided that the first sealing element and/or the second sealing element, in an uncompressed state of the sealing arrangement, protrude beyond the first side of the layer and/or the second side of the layer in the vertical direction—i.e. the pressing direction, which is aligned parallel to a surface normal of the layer, for example the z-direction. The horizontal direction is parallel to the layer, that is, to the layer plane. When the sealing arrangement is pressed, the vertical protrusion is pressed laterally in the direction of the cut-out or through-opening so that the corresponding sealing element is essentially flush with the layer when pressed.

In many embodiments, the first sealing element is molded onto the inner edge of the through-opening and/or the second sealing element is molded onto the inner edge of the cut-out. In these embodiments, the first sealing element and/or the second sealing element can be configured as edge-molded sealing profiles.

The sealing arrangement may optionally comprise an elastomeric fluid guide structure with a plurality of fluid passages for passing a fluid from the through-opening to the cut-out or vice versa. Typically, the fluid guide structure is integrally formed with the first sealing element and/or the second sealing element. In some examples, the fluid guide structure connects the first sealing element to the second sealing element, for example, with a material bond. It can therefore be provided that the first sealing element and the second sealing element are formed from a single elastomeric element. The fluid passages can be configured as recesses in the fluid guide structure, which extend between protrusions of the fluid guide structure. Alternatively, the fluid passages can be completely surrounded by the elastomeric material of the fluid guide structure in a direction perpendicular to the flow direction of the fluid.

In some embodiments, the cut-out and the through-opening form a common opening in the frame-shaped layer. In this case, the cut-out and the through-opening can be spatially separated from each other by the elastomeric fluid guide structure, optionally separated from each other only by the elastomeric fluid guide structure. This means that only the material of the fluid guide structure can run between the cut-out and the through-opening, without the material of the layer being present here.

The sealing arrangement, that is the layer of the sealing arrangement, can have at least two through-openings. On the anode side, one of these through-openings can then be configured as a fluid inlet for the fluid, while the other of the through-openings can be designed as a fluid outlet for the same fluid and another fluid. On the cathode side, both through-openings can be configured as fluid outlets. The cut-out is then arranged between the two through-openings, in particular in the direction of fluid flow between the two through-openings.

The layer can be made of a metallic material such as aluminum, steel, titanium or stainless steel, plastic and/or combinations thereof. Since the layer may not come into contact with the fluid during use of the sealing arrangement (see above), the layer can be made of a material that does not have to be corrosion-resistant, such as aluminum or (stainless) steel.

For example, the first sealing element and/or the second sealing element are made of fluororubber, FKM, and/or ethylene-propylene-diene rubbers, EPDM and/or a silicone. The first sealing element and the second sealing element can be made of the same material or of different materials. The first sealing element and/or the second sealing element can each be formed as one piece. Optionally, both sealing elements can be configured as integral parts of a single sealing element.

According to an additional aspect of the present disclosure, a further sealing arrangement for an electrochemical system is provided. The sealing arrangement comprises a frame-shaped layer with a cut-out, wherein the layer surrounds, in the form of a frame, an electrochemically active region. The cut-out extends over this region and has an inner edge. The layer also has at least one through-opening with an inner edge for the passage of a fluid. The sealing arrangement further comprises an elastomeric fluid guide structure with a plurality of fluid passages for passing a fluid from the through-opening to the cut-out or vice versa.

The further sealing arrangement can be combined with the features of the sealing arrangement described above. Thus, the further sealing arrangement can be combined with the first sealing element and/or the second sealing element of the type described above, see above. The further sealing arrangement can also be used without the first sealing element and/or without the second sealing element.

According to another aspect of the present disclosure, a bipolar plate for an electrochemical system is provided. The bipolar plate comprises a flow field with an electrochemically active region and at least one through-opening for passing a fluid. The bipolar plate is essentially flat between the flow field and the through-opening. Furthermore, the bipolar plate is substantially flat in a first region adjacent to the through-opening and circumferentially surrounding the through-opening and/or in a second region adjacent to the flow field and circumferentially surrounding the flow field. Optionally, in said regions, the bipolar plate has no sealing elements such as sealing beads, elastomer seals and/or depressions for receiving elastomer seals. The sealing of the through-opening and/or the flow field as well as the fluid guidance between the through-opening and the flow field are therefore performed by the sealing arrangement described above, while the bipolar plate is configured for the electrical contacting and separation or distribution of the media. As the bipolar plate itself has no elastomer seal around the through-openings and the flow field, the bipolar plate can be removed, serviced, possibly cleaned, possibly recoated and reused relatively easily when servicing is required.

The aforementioned bipolar plate can be used in particular with one or both of the sealing arrangements described above. The sealing arrangement performs, for example, sealing functions and ensures that the through-openings of the bipolar plate are sealed by means of the first sealing element and the flow field of the bipolar plate is sealed by means of the second sealing element. In addition, the sealing arrangement performs the fluid guidance function between the through-opening and the flow field via the elastomeric material of the fluid guide structure. Typically, the flow field has a large number of channels that are formed in the bipolar plate, for example by embossing, hydroforming and/or deep drawing. The bipolar plate can be single-layered or double-layered, for example. The bipolar plate can be made of titanium or stainless steel, for example.

According to a third aspect, an arrangement for an electrochemical system is provided. The arrangement comprises at least one sealing arrangement of the type described above and at least one bipolar plate of the type described above. The sealing arrangement and the bipolar plate are positioned relative to one another in such a way that the through-openings of the bipolar plate and the sealing arrangement are arranged one above the other and the frame-shaped layer surrounds the flow field with the electrochemically active region of the bipolar plate. The first sealing element is designed to seal the through-opening of the bipolar plate. Alternatively or additionally, the second sealing element is designed to seal the electrochemically active region of the bipolar plate.

It may be provided that the through-opening formed in the bipolar plate is smaller than the through-opening formed in the layer.

The first sealing element and/or the second sealing element of the layer contact the bipolar plate. A plate body of the layer and a plate body of the bipolar plate can be made of different or the same materials. Since only the sealing elements of the layer may be in contact with the fluid, the layer can be made of a different material than the bipolar plate, for example, a material other than the relatively expensive titanium.

Two sealing arrangements of the type described above can be provided for each bipolar plate. The arrangement can have two sealing arrangements which are arranged on opposite sides of the bipolar plate, the first sealing elements of the sealing arrangements sealing the through-opening of the bipolar plate on both sides of the bipolar plate and/or the second sealing elements of the sealing arrangements sealing the electrochemically active region of the bipolar plate on both sides of the bipolar plate. The first of the two sealing arrangements can be provided on a cathode side of the bipolar plate, while the second of the two sealing arrangements can be provided on an anode side of the bipolar plate. The respective sealing arrangements may be arranged with respect to the bipolar plate in such a way that their fluid guide structures face the bipolar plate and may rest on the bipolar plate.

In addition, the arrangement can also have at least one insulation layer and/or insulation coating for electrical insulation. The insulation layer and/or insulation coating can be arranged on one side or both sides of the sealing arrangement. The insulation layer and/or insulation coating can be arranged between the frame-shaped layer of the sealing arrangement and the bipolar plate. The insulation coating can consist of a plastic layer. The plastic layer can comprise a polyester, for example, polyethylene terephthalate, PET, or polyethylene naphthalate, PEN, a polyimide, PI, or a polyether ether ketone, PEEK. These materials allow for reliable electrical insulation with a process-safe layer-like application and a low layer thickness. According to a further development, the plastic layer comprises a plastic film that is laminated onto the structurally rigid layer. For example, the plastic film is bonded to the structurally rigid layer using an adhesive, optionally an acrylic adhesive. Alternatively, the frame-shaped layer of the sealing arrangement can be arranged between the insulating layer and the bipolar plate. Optionally, there is no additional layer or coating between the first sealing element or the second sealing element and the bipolar plate, so that the respective sealing element rests directly on the bipolar plate. The respective sealing element is thus designed to seal the insulating layer against the at least one through-opening of the layer and/or the recess in the layer, so that the insulating layer does not come into contact with the fluid when the arrangement is used as intended. The first sealing element and/or the second sealing element are often also electrically insulating.

The arrangement can also have a membrane electrode assembly (MEA), which is located between two sealing arrangements, and/or a porous transport layer (PTL) or gas diffusion layer (GDL), which are arranged between the MEA and the flow field of the bipolar plate. The arrangement can also be suitable for anion exchange membrane electrolysis (AEM), e.g. for the conversion of CO₂.

According to a further aspect, an electrochemical system is proposed, for example, an electrolyser or fuel cell stack. The system comprises a plurality of sealing arrangements of the type described above, a plurality of bipolar plates of the type described above and/or a plurality of stacked arrangements of the type described above.

The electrochemical system may be, for example, an electrolyser. However, the present specification is not limited to an electrolyser. The electrochemical system may alternatively also be a fuel cell system or a redox flow battery. In one embodiment, where the electrochemical system is an electrolyser, water is often the reaction medium, while hydrogen or oxygen may be the product medium(s). In a fuel cell system, hydrogen and oxygen are often the reaction media, while water is the product medium.

The system can also be suitable for anion exchange membrane electrolysis (AEM), e.g. for the conversion of CO₂.

Examples of the sealing arrangement, the bipolar plate, the arrangement and the electrochemical system are shown in the attached figures and are explained in more detail in the following description.

### BRIEF DESCRIPTION OF THE FIGURES

FIG. 1 shows an exploded view of an individual cell of a prior art electrolyser.

FIG. 2 shows a top view of a bipolar plate according to the state of the art.

FIG. 3 shows schematic perspective view of a bipolar plate according to one embodiment.

FIG. 4 shows schematic perspective view of a cathode-side sealing arrangement according to one embodiment.

FIG. 5 shows schematically an enlarged view of a section of FIG. 4.

FIG. 6 shows a schematic perspective view of an anode-side sealing arrangement according to one embodiment.

FIG. 7 shows schematically an enlarged view of a section of FIG. 6.

FIG. 8 shows a schematic perspective view of a composite of bipolar plate and anode-side and cathode-side sealing arrangement, with a view of the anode side.

FIG. 9 shows schematically an enlarged view of a section of FIG. 8.

FIG. 10 shows a schematic perspective view of a composite of bipolar plate and cathode-side and anode-side sealing arrangement, with a view of the cathode side.

FIG. 11 shows schematically an enlarged view of a section of FIG. 10.

FIG. 12 shows the composite of FIG. 8 with marked section lines A-A and B-B.

FIG. 13A shows a sectional view along cross-section A-A of FIG. 12.

FIG. 13B shows an enlarged view of a first portion of FIG. 13A.

FIG. 13C shows an enlarged view of a second portion of FIG. 13A.

FIG. 14A shows a sectional view along cross-section B-B of FIG. 12.

FIG. 14B shows an enlarged view of a section of FIG. 14A in the unpressed state.

FIG. 14C shows an enlarged view of the section of FIG. 14B in the pressed state.

FIG. 15A shows a sectional view of a composite of bipolar plate and cathode-side and anode-side sealing arrangement in the region of a through-hole in the unpressed state.

FIG. 15B shows the sectional view of FIG. 15B in the pressed state.

FIG. 16 shows a perspective sectional view of an arrangement of bipolar plates, sealing arrangements and further components.

### DETAILED DESCRIPTION

Here and in the following, recurring features in different figures are each designated with the same or similar reference signs.

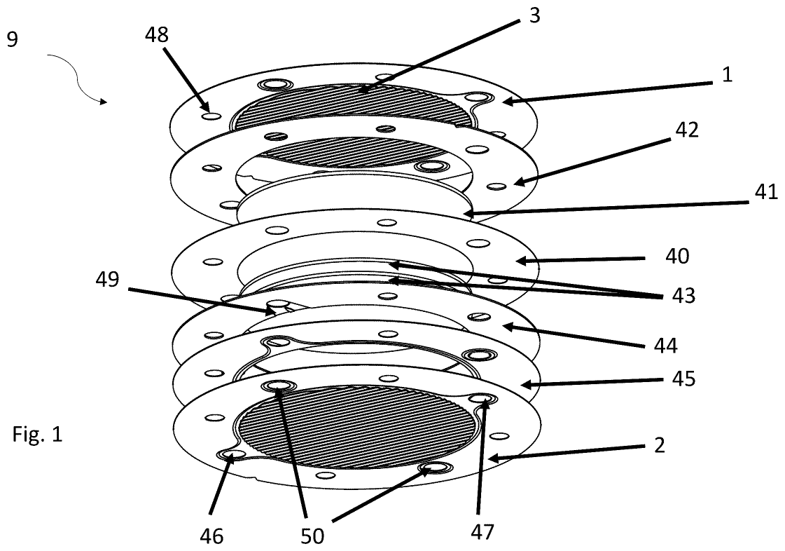

FIG. 1 shows an exploded view of an individual electrochemical cell 9, wherein the cell 9 is part of an electrolyser. Electrolysers typically comprise a large number of stacked individual cells 9. The individual cell 9 comprises two separator plates 1 and 2, two cell frames 42 and 44, a sealing layer 45, and a membrane electrode assembly 40 with media diffusion structures 41 and 43. For example, the media diffusion structure 43 comprises layers of carbon fleece, while the media diffusion structure 41 comprises metal, e.g. titanium. Here, the separator plate 1 is arranged, for example, on the anode side of the individual cell 9. In the exemplary embodiment shown, the separator plate 2 is arranged on the cathode side of the individual cell 9. The individual layers are compressed together to form an individual cell. The individual layers each have fluid passages 46, 47, 50, arranged in alignment one above the other, for the inward and outward passage of water, oxygen and hydrogen, as well as positioning holes 48.

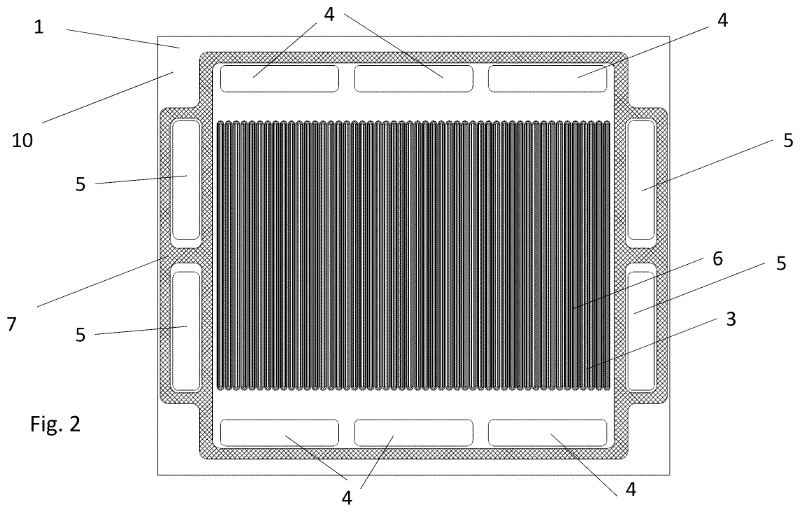

A flow field of the separator plate 2 is defined by projecting the cell frame 44 onto the separator plate 2. A flow field 3 of the separator plate 1 is defined by projecting the cell frame 42 onto the separator plate 1. The cell frame 42 has distribution channels (not shown) for distributing the water that is fed in. The through-openings 46, 47 are fluidically connected to the flow field 3 so that a medium can be routed from the through-opening 46 to the flow field 3, or from the flow field 3 to the through-opening 47. When a potential is applied, hydrogen (or oxygen) can be generated in the electrolyser from the supplied water. This can be discharged through the distribution channels 49 in the cell frame 44. It can then leave the cell through the through-openings 50. While the separator plates 1 shown in FIG. 1 have a round outer contour, other shapes are also possible. For example, the separator plates 1, 2 can have a rectangular outer contour, see FIG. 2.

The separator plates 1, 2 of FIGS. 1 and 2 are exemplary separator plates according to the prior art.

As already indicated above, a pressure difference between the environment and the interior of the electrochemical cell 9 can be more than 20 bar. The pressure on the product side, for example the hydrogen side, is often up to 40 bar, while the pressure on the reactant side, for example the water side, is only up to 2 bar. Sealing structures are therefore provided to seal the individual regions from each other.

For example, elastomer seals are used, which are arranged around the regions to be sealed, e.g. flow field 3 or through-openings 46, 47, 50. The elastomer seal is usually not provided over the entire surface, but only on the regions of the separator plate 1, 2 to be sealed and is firmly connected to the plate body of the respective separator plate 1, 2.

FIG. 2 shows a schematic top view of a separator plate 1 for an electrolyser. The separator plate 1 comprises a metallic layer 10, which for example consists at least predominantly or completely of titanium or stainless steel or alloys thereof. The metallic layer 10 can have a thickness of at least 0.1 mm and/or at most 0.8 mm. The separator plate 1 has a flow field 3, which is designed to distribute the water supplied from the through-openings 4 over as large an area as possible. Optional channel structures 6 are provided in the flow field 3 for this purpose. The through-openings 5 are designed to discharge hydrogen, whereby the fluid through-openings 5 are surrounded by an elastomer seal 7 on the side of the separator plate shown. The elastomer seal 7 ensures that the water cannot escape and that hydrogen or ambient air cannot enter.

Separator plates of fuel cells are often designed in two layers so that each layer can be processed individually, such as embossed, surface-treated, injection-molded, etc. Separator plates 1, 2 of electrolysers, on the other hand, are often designed as a single layer. For this reason, sealing elements 7 of separator plates in electrolysers must be provided on both sides of a single layer 10. In addition, the arrangement of sealing elements in a separator plate of an electrolyser leads to an accumulation of different sealing elements in a confined space. The sealing elements are also arranged alternately to seal both sides of the separator plate. The separator plate is therefore highly complex when it comes to sealing the through-openings 4, 5 and the flow field 3, both due to the small distance between the sealing elements and the alternating arrangement.

As mentioned at the beginning, there is therefore a constant need to improve the tightness of electrolysers and fuel cell stacks.

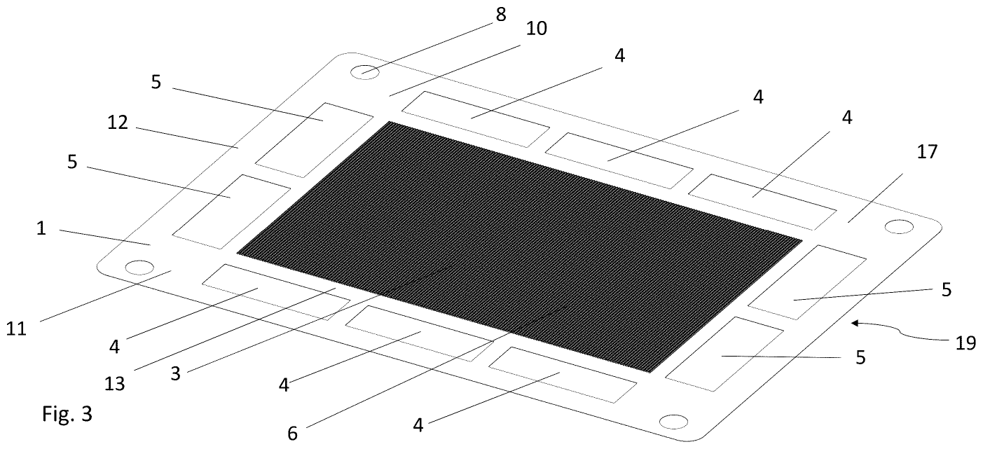

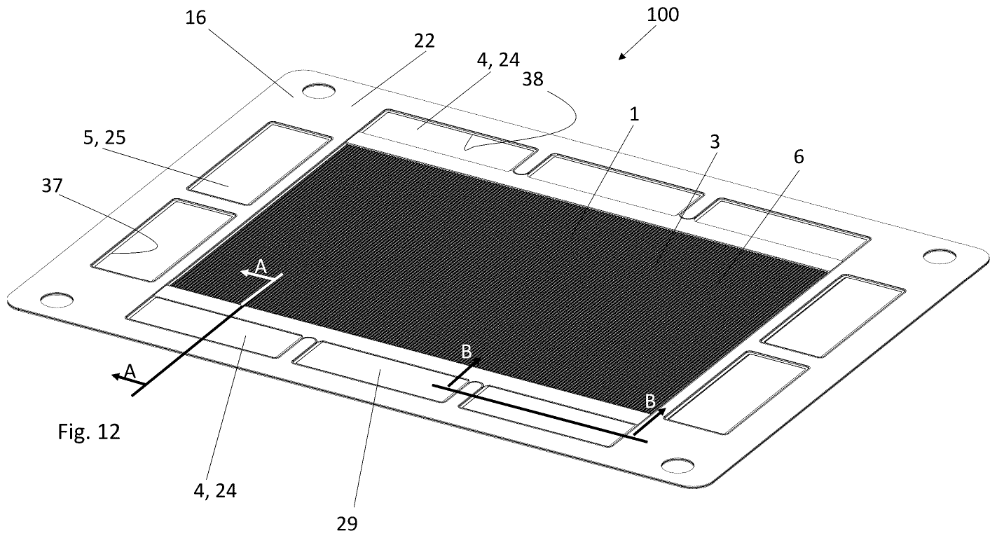

FIGS. 3-16 relate to various aspects and embodiments of the present disclosure.

FIG. 3 shows a top view of a bipolar plate 1 according to one embodiment of the present disclosure. Like the bipolar plate 1 of FIGS. 1 and 2, the bipolar plate of FIG. 3 also has a flow field 3 with an electrochemically active region and a plurality of through-openings 4, 5 for the passage of a fluid. The flow field 3 has a large number of channels 6, which are formed in the bipolar plate 1, for example by hydroforming, embossing and/or deep drawing. The bipolar plate 1 is usually single-layered, but can also be double-layered, for example in an embodiment in which the flow field 3 is mounted as an additional layer on a base plate. Centering holes 8 are often provided to accommodate centering pins so that the bipolar plate 1 can be aligned or centered.

In comparison and in contrast to the bipolar plate 1 of FIGS. 1 and 2, it is noticeable that the bipolar plate 1 is essentially flat between the flow field 3 and the through-opening 4, 5, i.e. it is configured as a flat surface there. The bipolar plate is designed as a flat, even plate outside the flow field 3 and apart from any through-openings 4, 5, 8, optionally everywhere outside the aforementioned regions 3, 4, 5, 8. The flat region 11 of the bipolar plate comprises, for example, a first sub-region 12 and a second sub-region 13. The first flat region 12 is adjacent to the through-opening 4, 5 and completely surrounds the through-opening 4, 5. The second flat region 13 is adjacent to the flow field 3 and completely surrounds it. The bipolar plate has no sealing elements or other protrusions or recesses in the aforementioned regions 11, 12, 13. These regions 11, 12, 13 are therefore free of sealing beads, elastomer seals, elastomer bulges and/or recesses for accommodating sealing elements.

The bipolar plate 1 has two opposite sides 17, 19, whereby in FIG. 3 only the first side 17 (front side of the bipolar plate 1) is visible and the second side 19 (rear side of the bipolar plate 1) is concealed from the viewer. Due to the absence of sealing elements in the bipolar plate 1, both sides 17, 19 of the bipolar plate 1 can have the same or identical design, so that the bipolar plate 1 has an axis of rotational symmetry running through the plane of the bipolar plate 1 and parallel to the plane of the bipolar plate 1. A rotation of 180° around this axis of rotational symmetry results in the same arrangement of the bipolar plate 1, apart from the fact that the channels 6 in the flow field 3 are oriented in the opposite direction. In the example shown, the bipolar plate 1 is single-layered and made of titanium.

The sealing of the flow field 3 and the sealing of the fluid passages 4, 5 are realized by a sealing arrangement 15, 16, separate from the bipolar plate, which is described below.

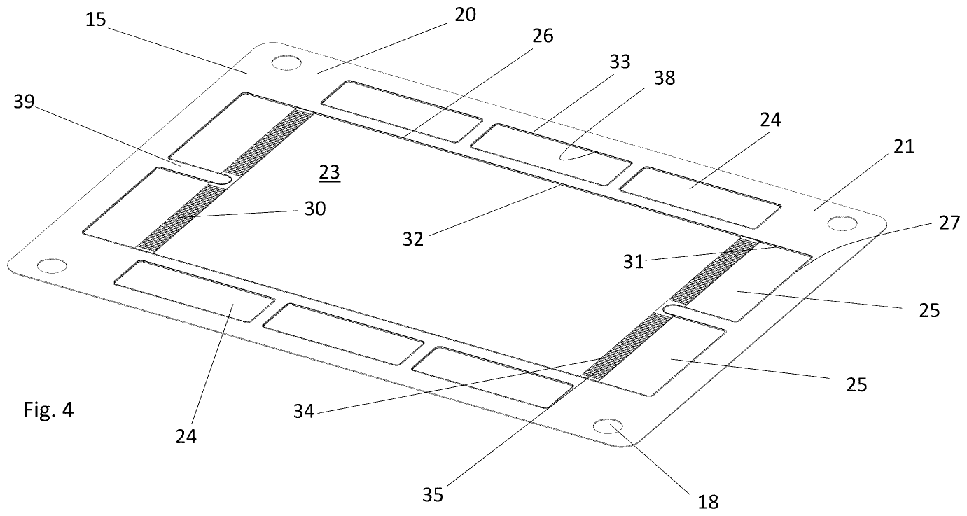

FIGS. 4-7 show perspective views of a sealing arrangement 15, 16 for an electrochemical system, wherein the sealing arrangement 15, 16 is configured for sealing the regions 3, 4, 5 of the bipolar plate 1 of FIG. 3.

The sealing arrangement 15, 16 has a frame-shaped layer 20, which can be made of metal and/or plastic. The frame-shaped layer 20 comprises a cut-out 23 with an inner edge 26. The layer 20 or the inner edge 26 of the cut-out 23 surrounds an electrochemically active region in the shape of a frame, with the cut-out 23 extending over this region. The cut-out 23 may be aligned with the electrochemically active region of the flow field 3 of the bipolar plate 1 of FIG. 3, so that the cut-out 23 of layer 2 and the electrochemically active region of the bipolar plate 1 overlap.

The layer 20 also has at least one through-opening 24, 25 with an inner edge 27, 28 for the passage of a fluid. The through-openings 24, 25 of the layer 20 are typically aligned with the through-openings 4, 5 of the bipolar plate 1 of FIG. 3. The through-openings 4, 24 and through-openings 5, 25 stacked on top of each other in an electrochemical cell form fluid lines 29 through which reaction or product media can flow. The layer 20 of the sealing arrangement 15, 16 can, for example, have at least two through-openings 24, 25. In the figures, the through-openings 24, 25 of the sealing arrangement 15, 16 or the through-openings 4, 5 of the bipolar plate are provided with the same reference sign if they transport fluid(s) flowing on the anode side or the cathode side of the bipolar plate 1. For example, in the case of an electrolyser, the through-openings 5, 25 are designed to remove the hydrogen generated in the electrochemical cell. The through-openings 4, 24 are designed for the ingress of water or the egress of water and oxygen. The layer 20 of the sealing arrangement 15, 16 has a first side 21 (front side) and a second side 22 (rear side), which are arranged opposite each other.

The sealing arrangement 15, 16 also has a first elastomeric sealing element 31, 33, which rests against the inner edge 27, 28 of the through-opening 4, 5 and projects laterally into the through-opening 24, 25 in order to seal the through-opening 24, 25. Optionally, the first sealing element 31, 33 is in circumferential contact with the inner edge 27, 28 of the through-opening 24, 25. The first sealing element 31, 33 is usually molded onto the inner edge 27, 28 of the through-opening 24, 25 in an edge-molding process.

In addition, the sealing arrangement 15, 16 has a second elastomeric sealing element 32, which rests against the inner edge 26 of the cut-out 23 and projects laterally into the cut-out 23 in order to seal the cut-out 23. Optionally, the second sealing element 32 is in circumferential contact with the inner edge 26 of the cut-out 23. The second sealing element 32 is usually molded onto the inner edge 26 of the cut-out 23 in an edge-moulding process. The first sealing element 31, 33 and/or the second sealing element 32 are often also electrically insulating.

During use of the sealing arrangement 15, 16, the first sealing element 31 and the second sealing element 32 may be in contact with the respective fluid flowing through the through-opening 24, 25 or through the cut-out 23. The layer 20, that is, the material of the layer 20 cannot be in contact with the fluid (or fluids) due to the sealing of the sealing elements 31, 32. This allows materials to be used for layer 20 which may not be chemically resistant to the fluids used or incompatible with the fluids used, such as H₂, O₂ and H₂O, under the operating conditions of the electrochemical cell. This means that more cost-effective and/or mechanically advantageous materials can be used, which cannot be used in conventional systems in which the material of layer 20 comes into contact with the fluids.

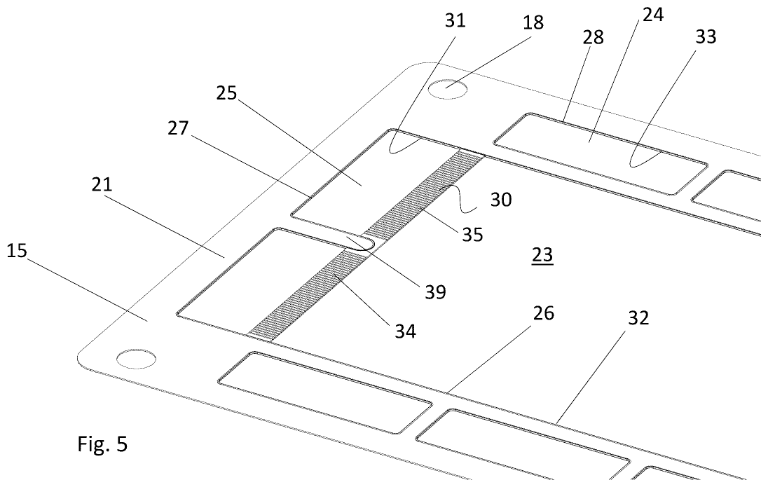

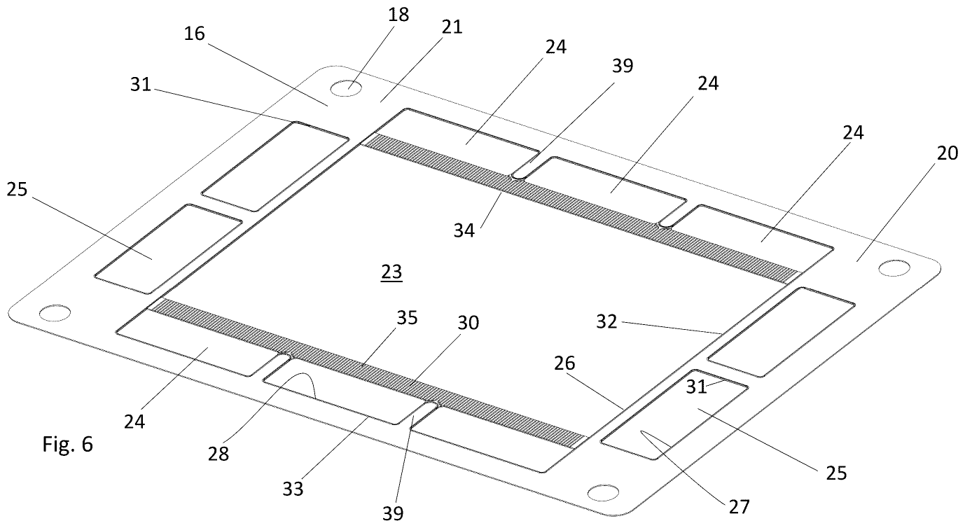

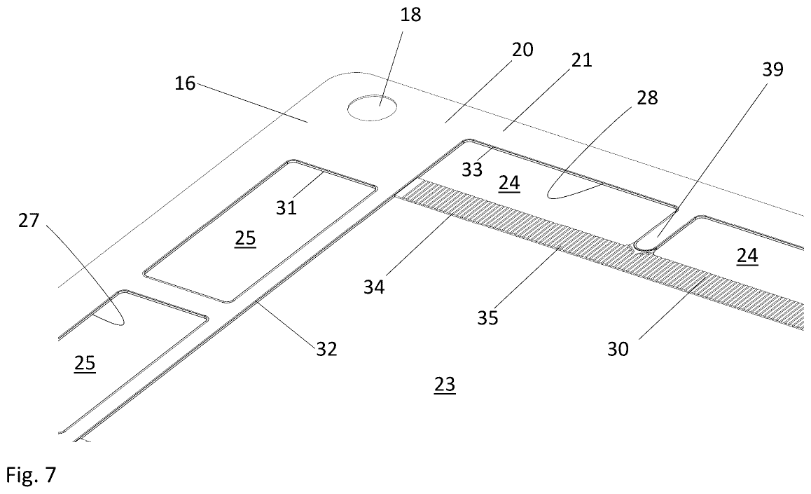

To enable the fluid to pass from the through-opening 24, 25 to the cut-out 23 and thus to the electrochemically active region, a fluid guide structure 34 with a plurality of fluid passages 35 can be provided. The fluid guide structure 34 is optionally also formed from an elastomer and is designed to guide the fluid from the through-opening 24, 25 to the cut-out 23 or vice versa. The fluid guide structure 34 is sometimes also called the distribution or collection region, because fluid is distributed there from the through-opening to the electrochemically active region or collected from the electrochemically active region and directed to the through-opening. It may be provided that the fluid guide structure 34 is formed integrally with the first sealing element 31, 33 and/or the second sealing element 32. Furthermore, the fluid guide structure 34 can connect the first sealing element 31, 33 to the second sealing element 32, optionally with a material bond. It may also be provided that the first sealing element 31, the second sealing element 32 and the fluid guide structure 34 are formed by the same element, cf. the one-piece sealing element 30 in FIGS. 4-5. Similarly, the first sealing element 33, the second sealing element 32 and the fluid guiding structure 34 may be formed by the same element, cf. the one-piece sealing element 30 in FIGS. 6-7.

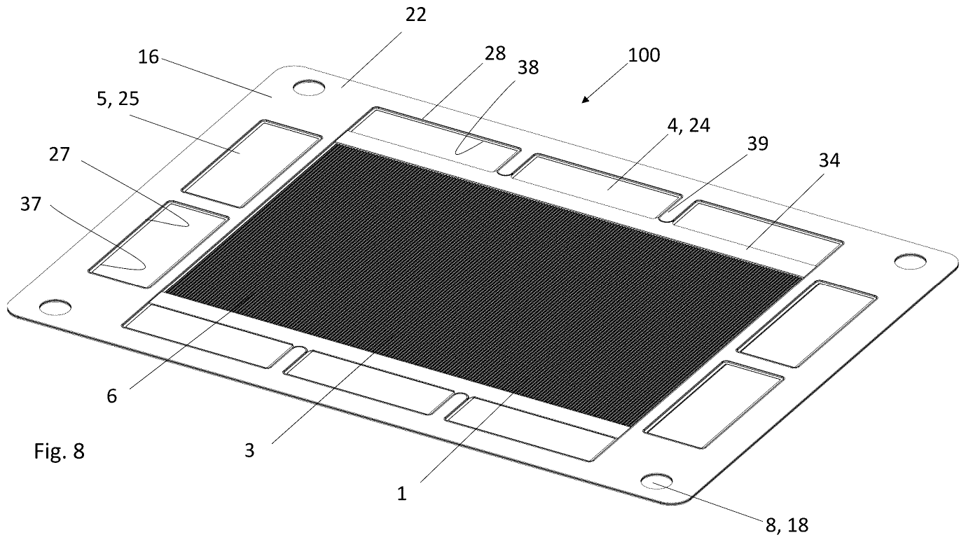

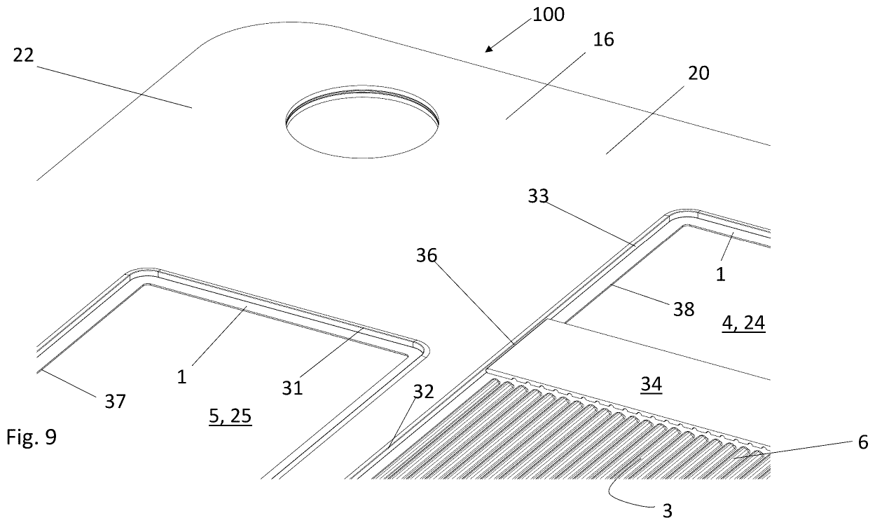

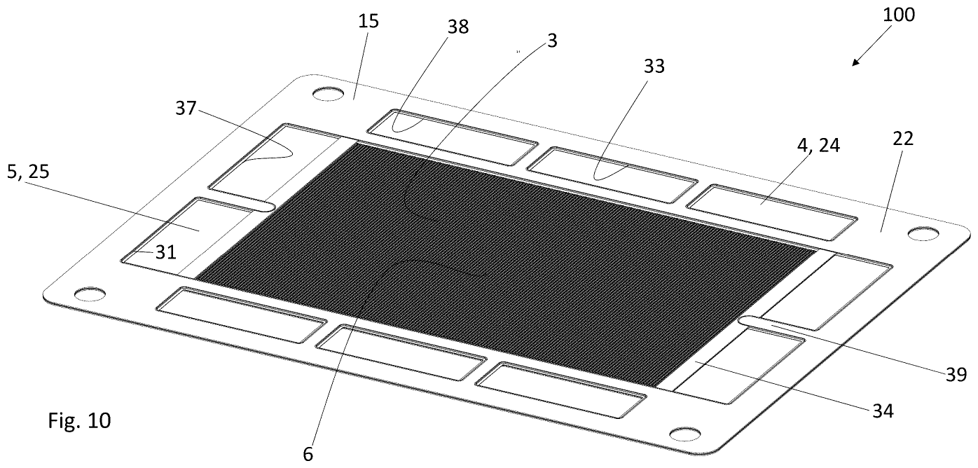

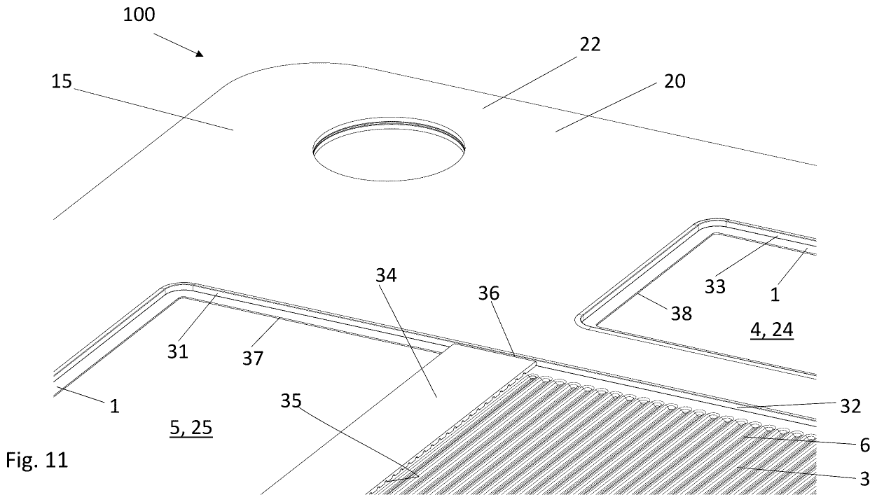

The cut-out 23 and the through-opening 24, 25 can form a common opening in the frame-shaped layer 20. In other words, the cut-out 23 and the through-opening 24, 25 of the layer 20 merge into one another before the sealing elements 31, 32, 33 are molded onto the layer 20 and/or before the sealing elements 31, 32, 33 are connected to the layer 20, or they are not separated from one another by metallic material of the layer 20. The spatial separation of the through-opening 24, 25 and the cut-out 23 is only achieved by the provision of the fluid guide structure 34, whereby the fluid guide structure 34 on the other hand enables the fluidic connection of the through-opening 24, 25 and the cut-out. The cut-out 23 and the through-opening 24, 25 can therefore be spatially separated from each other only by the elastomeric fluid guide structure 34. In particular, FIGS. 8-12 show the second side 22 of the layer 20 and thus also the rear side of the fluid guide structure 34, while FIGS. 4-7 show the first side 21 of the layer 20 or the front side of the fluid guide structure 34. Thus, no material of the metallic layer 20 extends in the direction of fluid flow between the through-openings 24 and the cut-out 23 of the anode-side sealing arrangement 16 (FIGS. 8, 9) or between the through-openings 25 and the cut-out 23 of the cathode-side sealing arrangement 15 (FIGS. 10, 11).

Separating elements 39 such as finger-shaped webs can be provided in the layer 20 in order to fluidically separate neighbouring through-openings 24, 25, which can pass the same fluids. The fluid guide structure 34 is optionally connected to end sections of the finger-shaped separating elements 39, or rests on the layer 20 in the region of the end sections of the separating elements 39. The optional separating elements 39 give the sealing arrangement 15, 16 additional mechanical stability by shortening the distance to be bridged by the fluid guide structure 34.

Exemplary materials for the first sealing element 31, 33, the second sealing element 32, the fluid guide structure 34 or the one-piece sealing element 30 are fluororubber, FKM and/or ethylene-propylene-diene rubbers, EPDM and/or silicone.

Described above are embodiments with a first sealing element 31, 33, a second sealing element 32 and a fluid guide structure 34. It should be noted that embodiments are conceivable in which the sealing arrangement has only a first sealing element 31, 33 (i.e. no second sealing element 32), only a second sealing element 32 (i.e. no first sealing element 31, 33) or neither of the two sealing elements 31, 32, 33. In all of the cases mentioned here, the sealing arrangement 15, 16 can have the fluid guide structure 34.

FIGS. 8-12 each show an arrangement 100 for an electrochemical system. The electrochemical system can therefore be realized by stacking a large number of arrangements 100. The arrangement 100 comprises the sealing arrangements 15, 16 of FIGS. 4-7 and the bipolar plate 1 of FIG. 3. Here, the sealing arrangements 15, 16 are arranged on both sides of the bipolar plate 1, i.e. on opposite sides 17, 19 of the bipolar plate 1, so that a sandwich arrangement of the elements 15, 1, 16 is formed. Here, the first side 21 of the respective sealing arrangement 15, 16 usually faces the bipolar plate 1, so that the second side 22 of the sealing arrangement 15, 16 is visible in FIGS. 8-12. Furthermore, each sealing arrangement 15, 16 and the bipolar plate 1 are positioned relative to one another in such a way that the through-openings 4, 5 of the bipolar plate 1 and the through-openings 24, 25 of the respective sealing arrangement 15, 16 are arranged one above the other to form fluid lines 29. Furthermore, each sealing arrangement 15, 16 and the bipolar plate 1 are aligned with each other in such a way that the frame-shaped layer 20 surrounds the flow field 3 with the electrochemically active region of the bipolar plate 1. The first sealing element 31, 33 is configured to seal the through-opening 4, 5 of the bipolar plate 1. Furthermore, the second sealing element 32 is configured to seal the electrochemically active region of the flow field 3 of the bipolar plate 1. The sealing arrangement 15 thus seals the regions 3, 4, 5 on the front side 17 of the bipolar plate 1, while the sealing arrangement 16 seals the regions 3, 4, 5 on the rear side 19 of the bipolar plate.

The sealing arrangements 15, 16 are generally positioned so that their fluid guide structures 34 face the bipolar plate 1. The fluid passages 35, which are configured as channel-shaped recesses, are thus covered by the bipolar plate 1.

It is typically provided that the through-opening 4, 5 formed in the bipolar plate 1 is smaller than the corresponding through-opening 24, 25 formed in the layer 20. In other words, the bipolar plate 1 protrudes laterally further into the fluid line 29 formed by the through-opening 4, 5 and the corresponding through-opening 24, 25 than the sealing arrangement 15, 16 or the sealing elements 31, 32, 33 of the sealing arrangement 15, 16.

For improved sealing of the regions 3, 4, 5 of the bipolar plate 1, the first sealing element 31, 33 and/or the second sealing element 32 of the layer 20 may contact the bipolar plate 1. This also ensures that the layer 20 does not come into contact with the fluid during operation of the electrochemical cell. This means that a plate body of the layer 20 and a plate body of the bipolar plate 1 can be made of different materials. It can also be provided that the plate body of the layer 20 is composed of several parts, i.e. segmented using methods from the prior art.

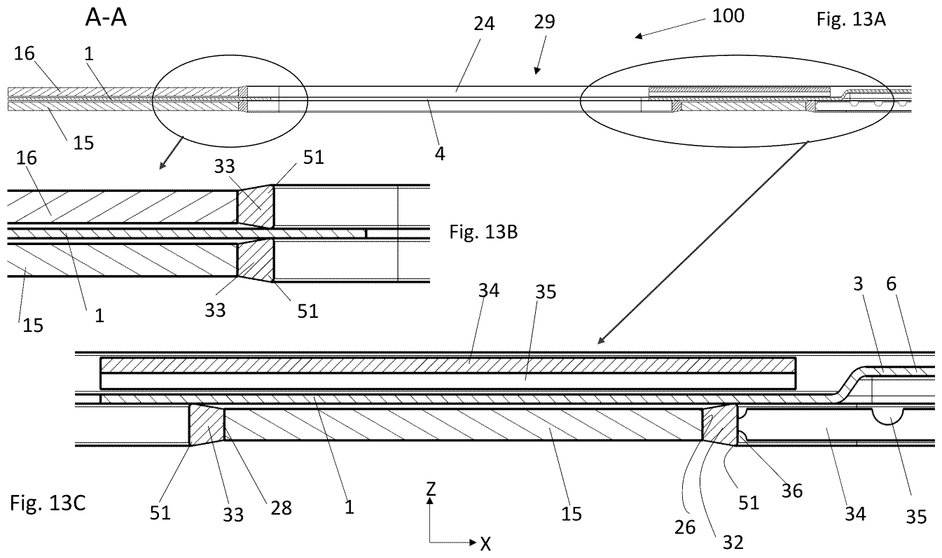

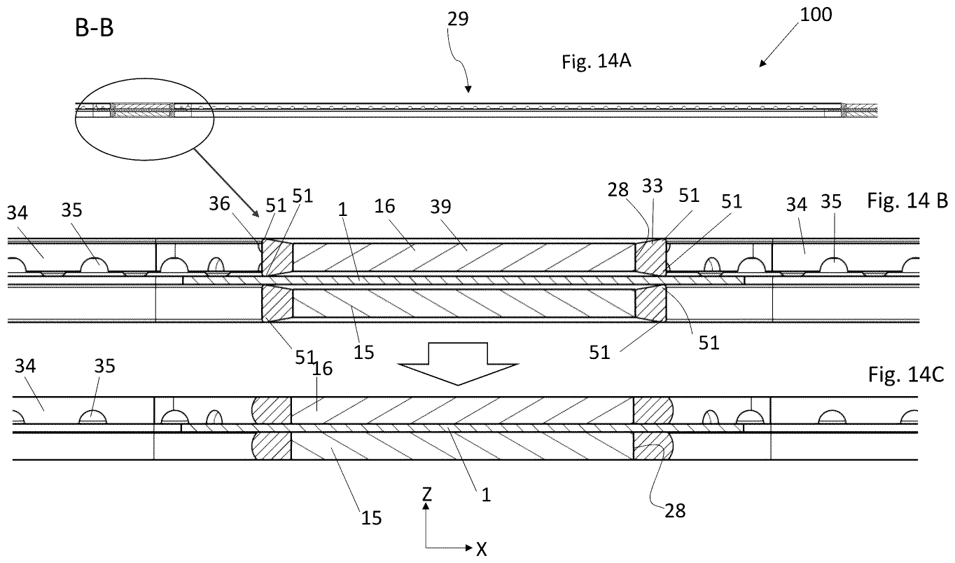

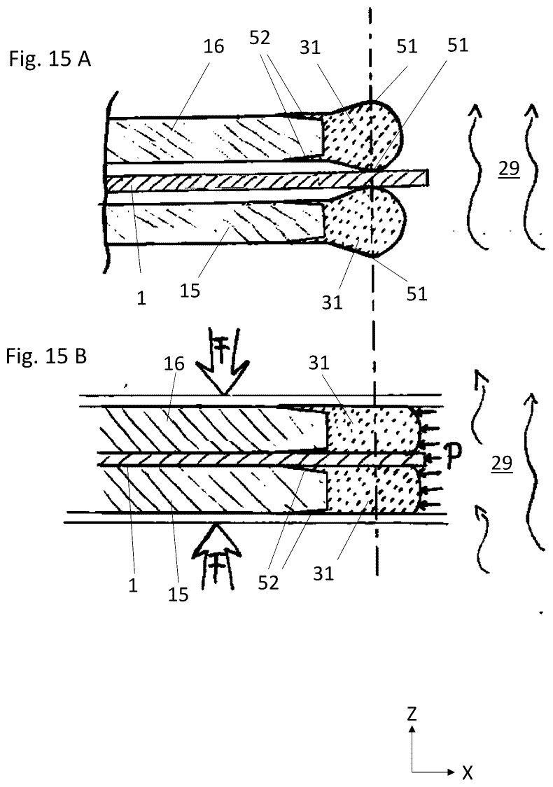

In an uncompressed state of the sealing arrangement 15, 16, the first sealing element 31, 33 and the second sealing element 32 protrude in a vertical direction beyond the first side 21 of the layer 20 and/or the second side 22 of the layer 20, see FIGS. 14B, 15A. The vertical direction is defined in such a way that it is parallel to the pressing force and perpendicular to the surface normal of the sealing arrangement 15, 16, see z-direction in FIGS. 13A-15B. The projection 51 of the respective sealing element 31, 32, 33, which thus protrudes beyond the flat sides 21, 22 of the layer 20 in the unpressed state of the sealing arrangements 15, 16, is recognizable, particularly in FIGS. 13A-15B. When the sealing arrangement 15, 16 is pressed together with the bipolar plate 1, the protrusion 51 is pressed laterally in the direction of the cut-out 23 or the through-opening 24, 25, so that the corresponding sealing element 31, 32, 33 is essentially flush with the layer 20 in the pressed state, cf. FIGS. 14C and 15B. The sealing elements 31, 32, 33 can be dimensioned or configured in such a way that their lateral extension in the compressed state of the sealing arrangement 15, 16 does not protrude beyond the bipolar plate 1 (or more precisely: an edge of the bipolar plate 1 in the region of the through-opening 4, 5), into the fluid line 29.

Optionally, a gap 36 can extend on the surface between the fluid guide structure 34 and the nearest sealing element 31, 32 in order to provide space for the fluid guide structure 34 to move out of the way during compression, see FIGS. 9 and 11.

According to the figures shown, the sealing arrangement 15 is designed to be arranged in a cathode chamber of the electrolyser, while the sealing arrangement 16 is arranged in an anode chamber of the electrolyser. However, the present disclosure is not limited to this. The sealing arrangements 15, 16 can also be used in a fuel cell stack or in other electrochemical systems.

FIGS. 4-14C also show that in the cathode-side sealing arrangement 15, the through-openings 4, 24 for the passage of water and/or oxygen are completely sealed all around by the first sealing element 31, while hydrogen generated in the electrochemically active region can pass through the fluid guide structure 34 to the through-openings 5, 25 and the fluid line 29.

Accordingly, in the anode-side sealing arrangement 16, the through-openings 5, 25 for the passage of hydrogen are completely sealed by the first sealing element 31, while water can pass from the through-openings 4, 24 through the fluid guide structure 34 to the electrochemically active region or the flow field 3. The generated oxygen can flow from the electrochemically active region together with the unreacted water through the fluid guide structure 34 to the through-openings 4, 24.

In the sandwich arrangement 100 of FIGS. 14A-15B, one sealing arrangement 15, 16 completely seals all around the through-openings, while the other sealing arrangement 16, 15 allows fluid flow from or to the electrochemically active region of the bipolar plate. In the sectional drawing of the sandwich arrangement 100 of FIG. 15A, chamfered or embossed edges 52 of the sealing arrangements 15, 16 can be seen, onto which the elastomeric sealing element 31 is molded. The advantage here is that the elastomeric sealing contour directly abutting the embossed edges 52 does not protrude significantly beyond the contours of the non-embossed parts of the sealing arrangements in the non-pressed state. This can result in the sealing effect shown in FIG. 15B in the pressed state.

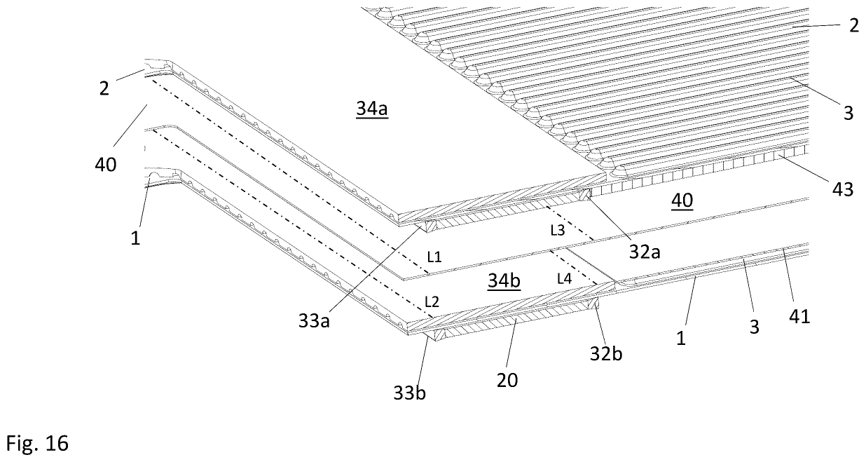

The arrangement 100 can comprise further layers. For example, the arrangement 100 also comprises at least one insulating layer, which is arranged between the frame-shaped layer 20 of the sealing arrangement 15, 16 and the bipolar plate 1. Alternatively, the frame-shaped layer 20 of the sealing arrangement 15, 16 can be arranged between the insulating layer and the bipolar plate 1. To ensure the sealing function, the insulation layer should not extend between the sealing element 31, 32, 33 and the bipolar plate 1. The respective sealing element 31, 32, 33 should therefore rest directly on the bipolar plate 1, even if other layers are present. Further additional elements are shown in FIG. 1, which can be combined with the arrangement 100 of FIGS. 8-14C. Thus, the arrangement can further comprise a membrane electrode assembly (MEA) 40, which is arranged on the side of the flow field 3 of the bipolar plate 1 and/or a porous transport layer (PTL) 41 or gas diffusion layer (GDL) 43, which is arranged between the MEA and the flow field 3 of the bipolar plate 1. This can be seen in FIG. 16. FIG. 16 shows, from top to bottom, sections of a sealing arrangement 16, a bipolar plate 2, a sealing arrangement 15, a membrane electrode unit 40, a further sealing arrangement 16 and a bipolar plate 1.

The dashed lines L1 to L4 show the resulting sealing lines of the sealing elements 33a and 32a as a projection onto the underlying MEA 40 and the fluid guide structure 34b of the subsequent sealing arrangement 16. The sealing lines L1 and L2 of the sealing element 33a seal the through-openings 24. The sealing line L3 seals the cathode chamber of the active region, whereas LA seals the anode chamber. The fluid guide structure 34b transfers the pressure to the bipolar plate 1.

It is apparent to a person skilled in the art that the features of FIGS. 1-16 described above can be combined with each other, provided they do not contradict each other, and are claimed individually.

### LIST OF REFERENCE SIGNS

1 separator plate
2 separator plate
3 flow field
4 through-opening for fluid
5 through-opening for fluid
6 channel structures
7 elastomer seal
8 centering opening
9 electrochemical cell
10 metallic layer of the bipolar plate
11 flat region
12 flat region
13 flat region
15 sealing arrangement
16 sealing arrangement
17 first side
18 centering opening
19 second side
20 frame-shaped layer
21 first side
22 second side
23 cut-out
24 through-opening
25 through-opening
26 inner edge of the cut-out
27 inner edge of the through-opening
28 Inner edge of the through-opening
29 fluid line
30 one-piece sealing element
31 first elastomeric sealing element
32 second elastomeric sealing element
33 first elastomeric sealing element
34 fluid guide structure
34a fluid guide structure
34b fluid guide structure
35 fluid passage, recess in 34
36 gap
37 inner edge of the fluid through-opening
38 inner edge of the fluid through-opening
39 partition element
40 membrane electrode assembly
41 media diffusion structure
42 cell frame
43 media diffusion structure
44 cell frame
45 sealing layer
46 fluid passage opening
47 fluid passage opening
48 positioning hole
49 hydrogen distribution channels
50 hydrogen through-opening
51 protrusion
52 chamfered/embossed edges of sealing arrangements 15,16
100 arrangement
L1 sealing line
L2 sealing line
L3 sealing line
L4 sealing line

1. A sealing arrangement for an electrochemical system comprising
a frame-shaped layer with a cut-out, wherein the layer surrounds, in the form of a frame, an electrochemically active region, wherein the cut-out extends over the electrochemically active region and has an inner edge, wherein the layer additionally has at least one through-opening with an inner edge for passing a fluid, and
a first elastomeric sealing element which lies against the inner edge of the through-opening and projects laterally into the through-opening in order to seal the through-opening and/or
a second elastomeric sealing element, which lies against the inner edge of the cut-out (and projects laterally into the cut-out in order to seal the cut-out,
the sealing arrangement further comprising an elastomeric fluid guide structure having a plurality of fluid passages for passing a fluid from the through opening to the cut-out or vice versa.

2. The sealing arrangement according to claim 1, wherein the first sealing element circumferentially abuts against the inner edge of the through-opening and/or wherein the second sealing element circumferentially abuts against the inner edge of the cut-out, wherein the first sealing element and/or the second sealing element are in contact with the fluid during use of the sealing arrangement.

3. The sealing arrangement according to claim 1, wherein the layer has a first side and a second side that are arranged opposite one another, wherein in an uncompressed state of the sealing arrangement the first sealing element and/or the second sealing element projects in the vertical direction beyond the first side of the layer and/or the second side of the layer.

4. The sealing arrangement according to claim 1, wherein the first sealing element is molded onto the inner edge of the through-opening and/or the second sealing element is molded onto the inner edge of the cut-out.

5. The sealing arrangement according to claim 1, wherein the fluid guide structure is integrally formed with the first sealing element and/or the second sealing element.

6. The sealing arrangement according to claim 1, wherein the fluid guide structure connects the first sealing element to the second sealing element with a material bond.

7. The sealing arrangement according to claim 1, wherein the cut-out and the through-opening form a common opening in the frame-shaped layer, wherein the cut-out and the through-opening are separated from each other by the elastomeric fluid guide structure.

8. The sealing arrangement according to claim 1, wherein the at least one through-opening is at least two through-openings that are designed as a fluid inlet and a fluid outlet, respectively, wherein the cut-out is arranged between the two through-openings.

9. The sealing arrangement according to claim 1, wherein the layer is made of a metallic material, a plastic material, and/or combinations thereof, wherein the first sealing element and the second sealing element are made of the same material.

10. The sealing arrangement according to claim 1, wherein the first sealing element and/or the second sealing element are each formed as a single piece and both are configured as integral components of a single sealing element.

11. A sealing arrangement for an electrochemical system comprising a frame-shaped layer with a cut-out, wherein the layer surrounds, in the form of a frame, an electrochemically active region, wherein the cut-out extends over the electrochemically active region and has an inner edge, wherein the layer additionally has at least one through-opening with an inner edge for passing a fluid,
the sealing arrangement further comprises an elastomeric fluid guide structure having a plurality of fluid passages for passing a fluid from the through-opening to the cut-out or vice versa.

12. A bipolar plate for an electrochemical system, comprising:
a flow field with an electrochemically active area, and
at least one through-opening for passage of a fluid,
wherein the bipolar plate is substantially flat between the flow field and the through-opening, wherein the bipolar plate is substantially flat in a first region adjacent to the through-opening and circumferentially surrounding the through-opening and/or in a second region adjacent to the flow field and circumferentially surrounding the flow field, and wherein the bipolar plate in the first region and the second region is free of sealing thicknesses, elastomer seals and/or recesses for accommodating flow field elastomer seals.

13. The bipolar plate according to claim 12, wherein the flow field comprises a plurality of channels that are formed in the bipolar plate.

14. An arrangement for an electrochemical system, comprising a sealing arrangement and the bipolar plate according to claim 12, wherein the sealing arrangement and the bipolar plate are positioned relative to one another in such a way that the at least one through-opening of the bipolar plate and a second through-opening in a frame-shaped layer of the sealing arrangement are arranged above one another and the frame-shaped layer surrounds the flow field with the electrochemically active area of the bipolar plate, wherein a first sealing element is configured to seal the at least one through-opening of the bipolar plate and/or wherein a second sealing element is configured to seal the electrochemically active area of the bipolar plate.

15. The arrangement according to claim 14, wherein the at least one through-opening formed in the bipolar plate is smaller than the second through-opening formed in the frame-shaped layer.

16. The arrangement according to claim 14, wherein the first sealing element and/or the second sealing element of the frame-shaped layer contacts the bipolar plate.

17. The arrangement according to claim 16, wherein a plate body of the frame-shaped layer and a plate body of the bipolar plate consist of different materials.

18. The arrangement according to claim 14, comprising two sealing arrangements that are arranged on opposite sides of the bipolar plate, wherein the first sealing elements of the two sealing arrangements seal the through-opening of the bipolar plate on both sides of the bipolar plate and/or the second sealing elements of the two sealing arrangements seal the electrochemically active area of the bipolar plate on both sides of the bipolar plate.

19. The arrangement according to claim 14 comprising at least one insulating layer, wherein the insulating layer is arranged between the frame-shaped layer of the sealing arrangement and the bipolar plate or wherein the frame-shaped layer of the sealing arrangement is arranged between the insulating layer and the bipolar plate.

20. An electrochemical system, comprising a plurality of stacked arrangements according to claim 14.
